(19) United States
(12) Patent Application Publication
(10) Pub. No.: US 2012/0315624 A1
(43) Pub. Date: Dec. 13, 2012

(54) Using LNA Flow-Fish to Quantitatively Monitor Viral Infections in Infected Cells and Test the Efficacy of Antiviral Medications

(76) Inventors: Eddie L. Chang, Silver Spring, MD (US); Kelly L. Robertson, Arlington, VA (US)

(21) Appl. No.: 13/489,689

(22) Filed: Jun. 6, 2012

Related U.S. Application Data
(60) Provisional application No. 61/494,292, filed on Jun. 7, 2011.

(51) Int. Cl. G01N 21/64

(52) U.S. Cl. 435/5

(57) ABSTRACT

As described herein, locked nucleic acids are used with flow cytometric-fluorescence in situ hybridization (LNA flow-FISH) detection of viral RNA in infected cells. This technique represents a straightforward way to monitor viral infection in cells and can be used to measure efficacy of potential antiviral compounds.

### CROSS-REFERENCE TO RELATED APPLICATIONS

This Application claims the benefit of U.S. Provisional Application 61/494,292 filed on Jun. 7, 2011.

### BACKGROUND

Flow cytometry-fluorescence in situ hybridization (flow-FISH) is a technique that allows the in situ detection of specific nucleic acid sequences (RNA and DNA). Flow-FISH typically involves the fixation of cells, followed by permeabilization and hybridization using a nucleic acid probe that is complementary to the sequence of interest. Flow-FISH has been used for telomere length determination, the analysis of microorganisms, and the detection of messenger RNA (mRNA) and viral RNA (see refs. 1-6). In flow-FISH each cell is treated as an independent observation, thereby enabling the detection of cells containing specific nucleic acid sequences and the quantification of the number of infected cells in a population.

Flow-FISH can be performed with probes containing natural nucleic acid or nucleotide analogs. In previous FISH experiments, probes containing peptide nucleic acid (PNA) or locked nucleic acid (LNA) have shown improved hybridization characteristics over their DNA counterparts (see refs. 7-11). The success of nucleic acid analog probes is due to their higher affinity for DNA and RNA which allows a decrease in hybridization time and an increase in hybridization temperature resulting in a faster and more sensitive technique. Viral nucleic acid detection using flow-FISH has been performed on a limited number of latently infected cell lines and clinical samples (see refs. 12-15).

A need exists for a simple and rapid method to detect viral infection.

### BRIEF SUMMARY

In one embodiment, a method of testing potential antiviral compounds includes providing cells infected with a virus, contacting the cells with a candidate antiviral compound, contacting the cells with a locked nucleic acid (LNA) probe directed at RNA of the virus under conditions suitable for hybridization, staining the cells with a stain adapted to bind to the LNA probe, and analyzing the cells with flow cytometry thereby detecting the presence or absence of the stain in the cells, and thereby the level of viral infection.

In a further embodiment, a method of monitoring viral infection includes providing cells known or suspected of being infected with a virus, contacting the cells with an LNA probe directed at RNA of the virus under conditions suitable for hybridization, staining the cells with a stain adapted to bind to the LNA probe, and analyzing the cells with flow cytometry thereby detecting the presence of the stain in the cells.

### BRIEF DESCRIPTION OF THE DRAWINGS

FIG. 1 shows measures of specific binding of the Sindbis virus LNA probe. FIG. 1A shows binding with no infection; FIG. 1B shows four hours post infection. Nonspecific LNA probe is shown with a solid line while the SV LNA (dotted line).

FIG. 2 shows SV LNA flow-FISH versus EGFP detection of Sindbis RNA over time. Histograms showing representative flow cytometry data for specific time points for SV LNA in FIG. 2A and EGFP in FIG. 2B.

FIG. 3 shows the number of cells positive for SV over time as detected by SV LNA (squares) and EGFP (circles) in the left panel. The right panel shows normalized qRT-PCR data showing the relative amount of SV RNA at each time. The qRT-PCR data was normalized relative to the “no infection” expression level. Each point shown is the mean value of three replicates; error bars indicate standard error.

FIG. 4 shows the effects of the antiviral ribavirin. Bar graph shows the mean fluorescence intensity of SV LNA flow-FISH versus EGFP.

### DETAILED DESCRIPTION

Definitions

Before describing the present invention in detail, it is to be understood that the terminology used in the specification is for the purpose of describing particular embodiments, and is not necessarily intended to be limiting. Although many methods, structures and materials similar, modified, or equivalent to those described herein can be used in the practice of the present invention without undue experimentation, the preferred methods, structures and materials are described herein. In describing and claiming the present invention, the following terminology will be used in accordance with the definitions set out below.

As used in this specification and the appended claims, the singular forms “a”, “an,” and “the” do not preclude plural referents, unless the content clearly dictates otherwise.

As used herein, the term “and/or” includes any and all combinations of one or more of the associated listed items.

As used herein, the term “about” when used in conjunction with a stated numerical value or range denotes somewhat more or somewhat less than the stated value or range, to within a range of ±10% of that stated.

Description

A locked nucleic acid (LNA), often referred to as inaccessible RNA, is a modified RNA nucleotide. The ribose moiety of an LNA nucleotide is modified with an extra bridge connecting the 2′ oxygen and 4′ carbon. The bridge “locks” the ribose in the 3′-endo conformation, which is often found in the A-form duplexes. LNA nucleotides can be mixed with DNA or RNA residues in the oligonucleotide as desired. Such oligomers are synthesized chemically and are commercially available. The locked ribose conformation enhances base stacking and backbone pre-organization. This significantly increases the hybridization properties (melting temperature) of oligonucleotides.

As described herein, locked nucleic acid flow cytometry-fluorescence in situ hybridization (LNA flow-FISH) may be used to monitor viral infections in non-latently infected cells, with applications including assaying the effectiveness of antivirals.

This technique is expected to operate to measure essentially any viral RNA when using an appropriate LNA probe. As noted below, it has been used to detect Sindbis virus. It may be used with other members of that family of virus, Togaviridae, or that type of virus, namely one having an enveloped, single RNA genome, as well as other viruses.

Upon determination of the virus of interest, an LNA-containing oligonucleotide (an LNA probe) is designed to be complementary to the viral nucleic acid, preferably a nucleic acid encoding a structural component of the virus, and thus likely to be present in relatively great quantity. Optionally this is accomplished using suitable software such as the Exiqon Tm prediction program. The probe length and locked nucleic acid content of the LNA probe can be varied, preferably to get a melting temperature of approximately 75° C.

The LNA probe may have a “handle” that allows it to bind to a stain or other label, or it may be detected directly with a covalently linked stain without the use of such an intermediary.

### EXAMPLES

Sindbis virus (SV) was used to test the LNA flow-FISH method for the quantitative monitoring of a viral infection in cells. After infecting cells with SV, cells were collected at different timepoints and their mean fluorescence intensity (MFI) was measured using flow cytometry. The LNA flow-FISH technique was directly compared with a genetic recombination method of measuring viral infection—this was possible because the SV strain has an enhanced green fluorescent protein (eGFP) construct incorporated into the viral RNA. The LNA flow-FISH method was comparable to the eGFP method and gave detection at similar timepoints. In addition, lysed cells were used to compare the LNA flow-FISH results with QRT-PCR. Using the QRT-PCR, it was found that the LNA flow-FISH shows quantitative increases in MFI during the viral infection.

Cells were infected with the virus of interest and harvested at various timepoints during infection. Cells were harvested and fixed with 4% paraformaldehye and 5% acetic acid in phosphate-buffered saline (PBS) for 10 min at room temperature. After fixation, the cells were washed twice in PBS and stored at 4° C. until use.

A control oligonucleotide and a specific biotinylated LNA-modified DNA oligonucleotide were used for the quantification of SV RNA. The sequences of the probes along with other relevant details are found in reference 30. The control probe is a nonspecific 22-mer oligonucleotide (nonspecific LNA) lacking complementarity to cellular nucleic acids and having a Tₘ of 75° C. The specific LNA probe (SV LNA), complementary to the SV RNA portion encoding the structural proteins, was also a 22-mer with a Tₘ of 76° C. Each had approximately one-third locked nucleic acid content.

When ready to detect the virus present in the cells at various timepoints, the cells were permeabilized with 0.1 μg/mL Proteinase K in TE buffer (pH 8.0) for 30 min at 37° C. The cells were then washed twice with PBS. A pre-hybridization step was then carried out under the same conditions as the hybridization, but without LNA probe. After pre-hybridization, a solution of 0.1× saline-sodium citrate (SSC) buffer was added followed by centrifugation and removal of the supernatant. Hybridization was then carried out in hybridization buffer containing 20 pmol LNA (complementary to the viral nucleic acid), 50% formamide, 10% dextran sulfate, 50 nM NaPi (pH 7.0), 2×SSC, and 10 μg sheared salmon sperm DNA (SSSD). The sample was denatured for 90 sec at 80° C. and incubated with the cells at 60° C. for 90 min.

Following hybridization, 0.1×SSC buffer was added, the cells are centrifuged, and the supernatant removed. The cells were then washed at 65° C. twice with 50% formamide and 2×SSC buffer for 10 min each and twice with 0.1×SSC buffer for 20 min each. The cells were then blocked with 1× in situ hybridization blocking buffer and stained with PE-conjugated streptavidin for 15 min. The cells were then washed twice with 0.1×SSC buffer and twice with PBS for 5 min each at room temperature. The cells are then resuspended in PBS for flow cytometric analysis.

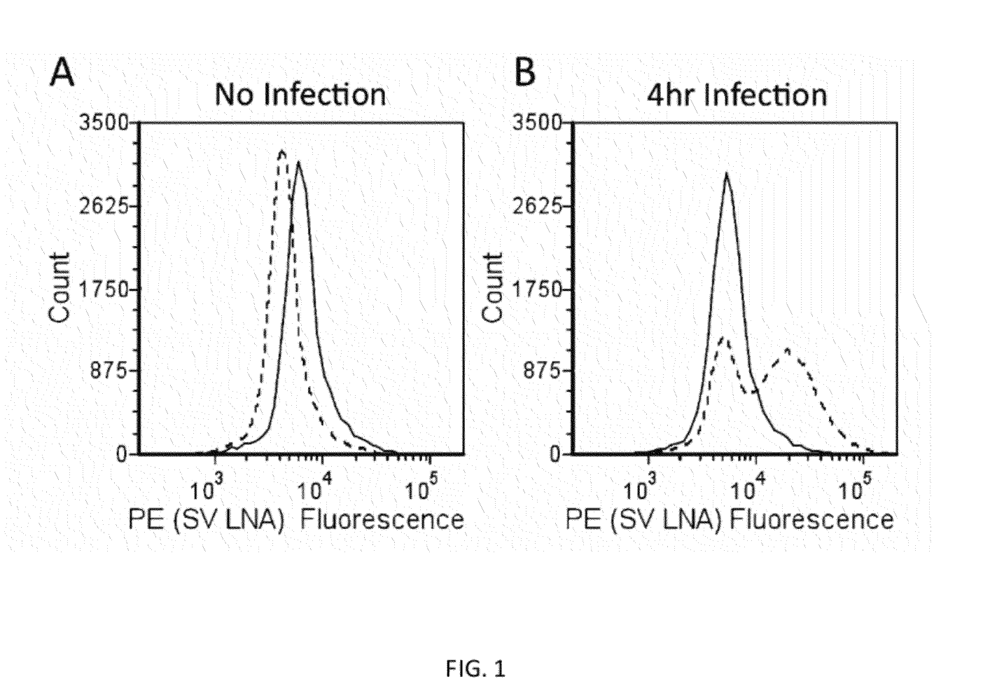

The signal from the SV LNA probe was tested for specific binding in BHK cells in the absence of infection (FIG. 1A) and at various times post-infection (FIG. 1B shows exemplary data from four hours post-infection). In the absence of infection, the SV LNA does not exhibit any nonspecific binding and, in fact, gives a slightly lower signal than the nonspecific LNA (FIG. 1A). At 4-h post-infection, the SV LNA probe shows a signal that correlates with increased SV RNA from virus replication (FIG. 1B). From the flow signals, one can also see that the SV LNA is detecting only the infected cells, while the uninfected cells (or infected cells that contain little or no quantity of SV RNA) are giving a signal in a region that corresponds with the nonspecific LNA signal. Overall, the LNA probe designed for SV RNA was found to be able to easily distinguish the proportion of cells that are infected and undergoing viral replication from the population that is either not infected or not in an actively replicating state.

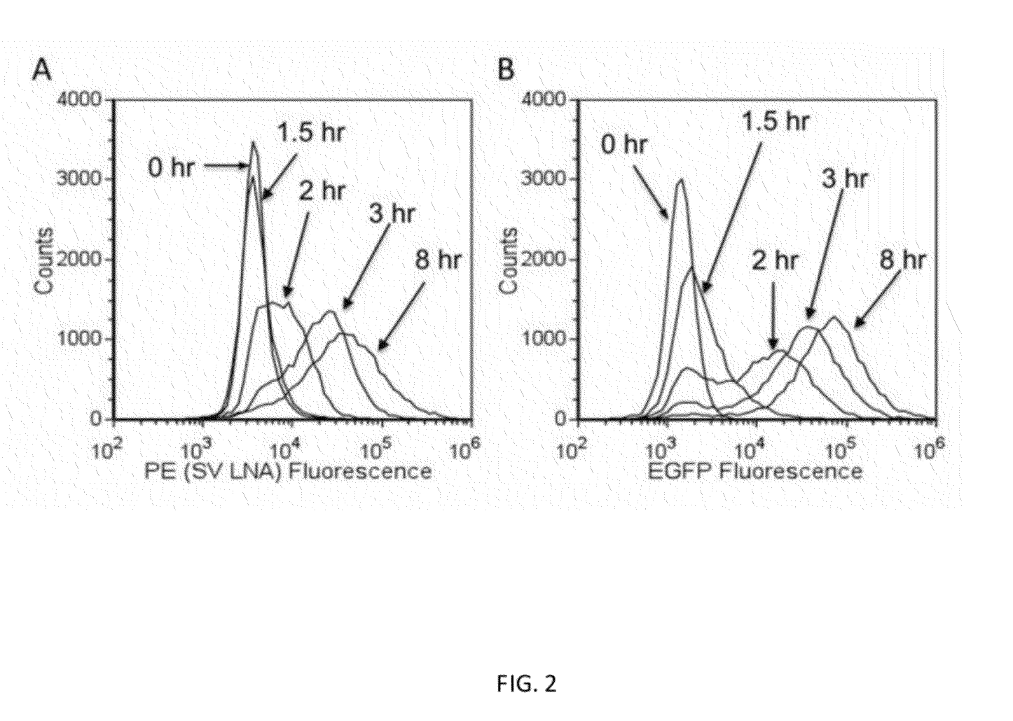

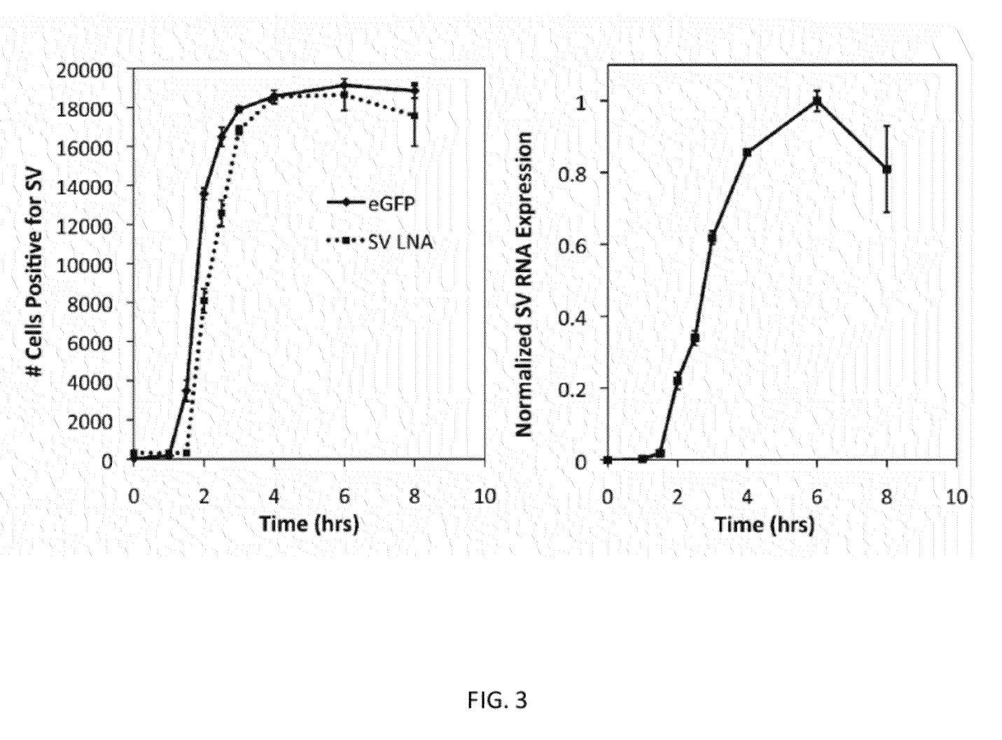

FIGS. 2A and 2B compare the flow cytometry histograms for the LNA flow-FISH and EGFP techniques at points corresponding to no infection, 1.5, 2, 3, and 8 h post-infection. The EGFP starts showing a shift in signal at 1.5 h, while the LNA flow-FISH can detect the SV RNA at 2 h. This difference is quantitatively displayed in FIG. 3, left panel, which shows the number of positive cells for SV at each time point (0, 1.5, 2, 2.5, 3, 4, 6, and 8 h). The EGFP signal increases at a slightly quicker rate than the signal from SV LNA, but both plateau to the same level after 3 h. The same peak-signal levels show that the LNA-flow-FISH method is comparable to the EGFP construct in sensitivity when measured by flow cytometry. The slight differences in dynamics may be due to the likelihood that more SV protein is expressed than the RNA template. The advantage of the LNA flow-FISH is that by simply changing the LNA probe, any virus can theoretically be detected, whereas in the case of EGFP, a new viral construct would be necessary for every virus or mutant.

Quantitative RT-PCR was used to confirm the LNA flow-FISH results. A standard curve was produced using viral RNA purified from SV supernatants. The standard curve was used to calculate the SV RNA expression at each time point relative to the expression at the no infection time point (FIG. 3, right panel). As expected, qRT-PCR could detect SV RNA in infected cells at the earliest time point of infection (45-min infection or 0-h Infection). Although the qRT-PCR and the LNA flow FISH method began detecting SV RNA at different times, the increases in the SV RNA expression level detected over time are very similar (FIG. 3, both panels). While qRT-PCR is a highly sensitive technique for viral detection in cell lysates, it provides no information regarding viral viability, individual cell phenotype, infection distribution in cellular populations, or the relationship between the cells and pathological features. In addition, the fast and simple flow-FISH method is inexpensive compared with the cost of primers, probes, and enzymes for qRT-PCR. The LNA flow-FISH method also allows the simultaneous examination of viral nucleic acids as well as host nucleic acids and/or proteins through multiplexing, providing valuable information about host cell response to infection.

Demonstration of Tracking of Antiviral Therapeutic Effects

To use the LNA flow-FISH method to study the efficacy of antiviral medication, before, during, or after infection, cells were treated with an antiviral compound and left for various amounts of time. The LNA flow-FISH method is then used as described above. The change in viral nucleic acid with antiviral treatment can be quantified by taking the mean fluorescence intensity (MFI) or by examining the percent of infected cells compared to uninfected cells.

As an example, Sindbis virus (SV) was used along with Ribavirin (Rbv), an antiviral, to test the LNA flow-FISH method for studying the action and efficacy of antiviral medications. Rbv is a nucleoside analog that inhibits the replication of many DNA and RNA viruses including Sindbis. Samples infected with SV with and without Rbv were analyzed by LNA flow-FISH.

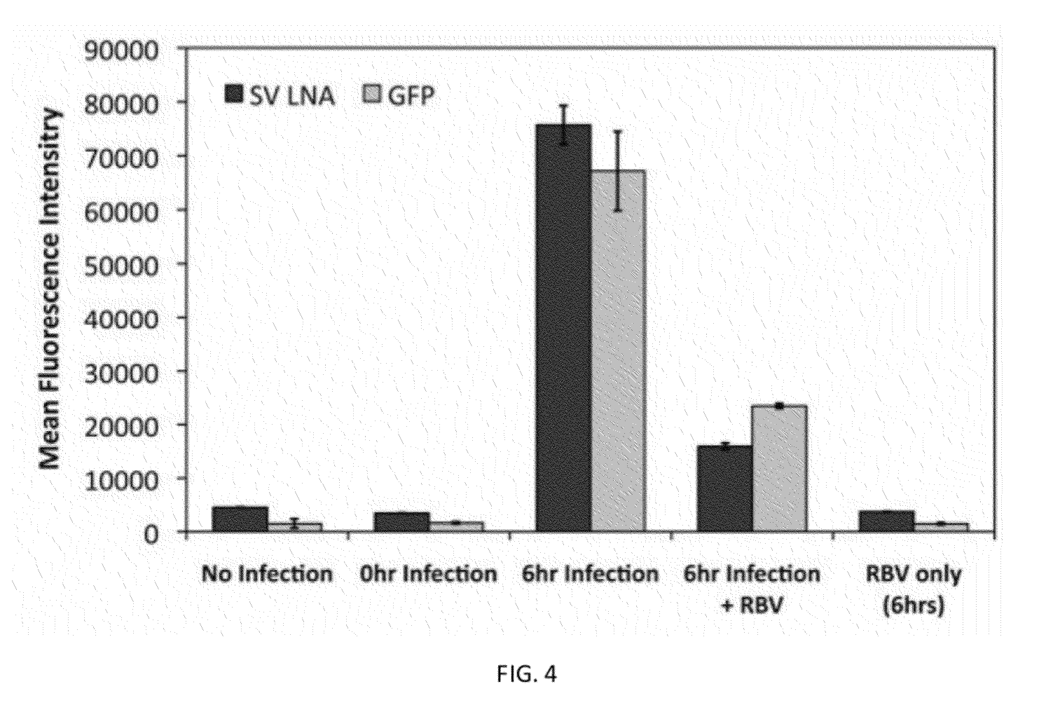

After a 6-h incubation with Rbv, both the flow-FISH and EGFP results showed a reduction in viral replication and viral expression, respectively (FIG. 4). The controls (no infection, 0 h infection [45 min virus incubation], and 6 h no infection+Rbv) all show no change in SV RNA. When Rbv was present, the MFI of the samples was drastically lower than that of samples without antiviral. In addition, no uninfected cells were observed. These results reconfirm the mechanism of Rbv in that it decreases the ability of the virus to replicate, but does not prevent the virus from entering the cell.

Advantages

This technique is superior to existing methods due to its simplicity. The use of the LNA flow-FISH method provides a cost-effective and simple technique, which can be easily applied to other viruses and used prior to other, more costly, and time-consuming techniques. When studying the action of antiviral medication, this technique allows one to gain information on the mode of action of the antiviral as well as quantify the number of infected cells in the presence and absence of the antiviral. This represents an important screening process for antivirals and provides more information than the more expensive QRT-PCR

Existing methods used for the detection and study of antiviral medications have particular limitations. Antibodies are widely used to detect viruses and viral proteins (see refs. 16-20), but due to their specificity, must be produced and calibrated for every target and are highly vulnerable to mutations, which occur often in many viruses. Quantitative reverse-transcription polymerase chain reaction (qRT-PCR), microarrays, and enzyme-linked immunosorbent assays (ELISAs) are other widely used methods to detect and quantify viruses (see refs. 21-25). These methods may be highly sensitive, but they each have shortcomings. Because cells must be lysed prior to these assays, none are able to provide information on viral or cellular viability or the relationship between cells and cytopathic phenotypes. In addition, since the signal is averaged over the number of input cells, one cannot associate a signal with an individual cell or determine the distribution of infection in a cellular population. This information is highly important when determining the efficacy of antivirals or when understanding the host genes involved in viral infection and replication. Simply knowing a quantity of virus in a lysed sample is not enough when trying to understand the action of the antiviral as well as its toxicity to both the host cells and the virus. Traditional plaque used for quantifying viral loads and for drug development can be time consuming and rely on visible signs of cell damage, which is not produced in all viruses and can take long periods of time to occur (see ref. 26). Other methods similar to LNA flow-FISH involve the genetic recombination of the virus to express a fluorescent protein upon translation of the viral RNA (see refs. 27-29). The signal corresponds well with the amount of virus present in individual cells, but this technique involves a large initial investment of labor.

### REFERENCES

WO 2004035819 Oligonucleotide analogs for detecting and analyzing nucleic acids of interest.
WO 03020739 Novel LNA compositions and uses thereof
1. Lansdorp P M, et al. (1996) Heterogeneity in telomere length of human chromosomes. Human Molecular Genetics 5(5):685-691.
2. Lischewski A, et al. (1996) Specific detection of Candida albicans and Candida tropicalis by fluorescent in situ hybridization with an 18S rRNA-targeted oligonucleotide probe. Microbiology 142(10):2731-2740.
3. Shu J, Sun G-Y, Liu A-P, & Liu J (2007) Diagnostic accuracy of human telomerase reverse transcriptase mRNA in malignant pleural effusions: A preliminary report for in situ hybridization detection. Clinica Chimica Acta 381:131-135.
4. Tata A M (2001) An in situ hybridization protocol to detect rare mRNA expressed in neural tissue using biotin-labelled oligonucleotide probes. Brain Research Protocols 6:178-184.
5. Borzì R M, et al. (1996) A fluorescent in situ hybridization method in flow cytometry to detect HIV-1 specific RNA. Journal of Immunological Methods 193:167-176.
6. Just T, Burgwald H, & Broe M K (1998) Flow cytometric detection of EBV (EBER snRNA) using peptide nucleic acid probes. Journal of Virological Methods 73:163-174.
7. Taneja K L (1998) Localization of trinucleotide repeat sequences in myotonic dystrophy cells using a single fluorochrome-labeled PNA probe. BioTechniques 24(3):472-475.
8. Thisted M, et al. (1996) Detection of immunoglobulin kappa light chain mRNA in paraffin section by in situ hybridization using peptide nucleic acid probes. Cell Vision 3(5):358-363.
9. Kubota K, Ohashi A, Imachi H, & Harada H (2006) Improved in situ hybridization efficiency with locked-nucleic-acid-incorporated DNA probes. Applied and Environmental Microbiology 72(8):5311-5317.
10. Silahtaroglu A N, Tommerup N, & Vissing H (2003) FISHing with locked nucleic acids (LNA): evaulation of different LNA/DNA mixmers. Molecular and Cellular Probes 17:165-169.
11. Silahtaroglu A, Pfundheller H, Koshkin A, Tommerup N, & Kauppinen S (2004) LNA-modified oligonucleotides are highly efficient as FISH probes. Cytogenetic Genome Research 107:32-37.
12. Lizard G, et al. (1993) Detection of human papillomavirus DNA in CaSki and HeLa cells by fluorescent in situ hybridization: Analysis by flow cytometry and confocal laser scanning microscopy. Journal of Immunological Methods 157:31-38.
13. Crouch J, Leitenberg D, Smith B R, & Howe J G (1997) Epstein-Barr virus suspension cell assay using in situ hybridization and flow cytometry. Cytometry 29:50-57.
14. Stowe R P, Cubbage M L, Sams C F, Pierson D L, & Barrett A D T (1998) Detection and quantification of Epstein-Barr virus EBER1 in EBV-infected cells by fluorescent in situ hybridization and flow cytometry. Journal of Virological Methods 75:83-91.
15. Narimatsu R & Patterson B K (2005) High-throughput cervical cancer screening using intracellular human papillomavirus E6 and E7 mRNA quantification by flow cytometry. Anatomic Pathology 123:716-723.
16. Cho S W, et al. (1996) In situ detection of hepatitis C virus RNA in liver tissue using a digoxigenin-labeled probe created during a polymerase chain reaction. Journal of Medical Virology 48:227-233.
17. Bentzen E L, House F, Utley T J, Crowe J E, & Wright D W (2005) Progression of respiratory syncytial virus infection monitored by fluorescent quantum dot probes. Nano Letters 5:591-595.
18. Dawson G J (2007) HCV core antigen and combination (antigen/antibody) assays for the detection of early seroconversion. Journal of Medical Virology 79:S54-S58.
19. Rabenau H F, Kessler H H, Kortenbusch M, Steinhorst A, & Berger R B (2007) Verification and validation of diagnostic laboratory tests in clinical virology. Journal of Clinical Virology 40:93-98.
20. Polage C R & Petti C A (2009) Clinical Virology Manual (American Society for Microbiology, Washington, D.C.).
21. Steininger C, Kundi M, Aberle S W, Aberle J H, & Popow-Kraupp T (2002) Effectiveness of reverse-transcription-PCR, virus isolation, and enzym-linked immunosorbent assay for diagnosis of influenza A virus infection in different age groups. Journal of Clinical Virology 40:2051-2056.
22. Wang D, et al. (2002) Microarray-based detection and genotyping of viral pathogens. Proceedings of the National Academy of Sciences 99:15687-15692.
23. Fox J D (2007) Nucleic acid amplification tests for detection of respiratory viruses. Journal of Clinical Virology (Suppl. 1) 40:S15-S23.
24. Leski T A, et al. (2009) Testing and validation of high density resequencing microarray for broad range biothreat agents detection. PLos ONE 4(8):e6569.
25. Mosleh N, Dadras H, & Mohammadi A (2009) Molecular quantification of H9N2 avian influenza virus in cultural conditions and of the host cell phenotype. Antiviral Research 1:287-299.
26. Los M (2006) Virus detection today. Modern Bacteriophage Biology and Biotechnology, ed Wegrzyn G (Research Signpost, Kerala, India), pp 131-152.
27. Thach D C & Stenger D A (2003) Effects of collagen matrix on Sindbis virus infection of BHK cells. Journal of Virological Methods 109:153-160.
28. Sanz M A, Castello A, & Carrasco L (2007) Viral translation is coupled to transcription in Sindbis virus-infected cells. Journal of Virology 81:7061-7068.
29. Delehanty J B, et al. (2008) Antiviral properties of cobalt (III)-complexes. Bioorganic and Medicinal Chemistry 16:830-837.
30. Kelly L. Robertson, Anne Brooks Verhoeven, Dzung C. Thach, and Eddie L. Chang. (2010). Monitoring viral RNA in infected cells with LNA flow-FISH. RNA 16: 1679-1685.
31. Kelly L. Robertson and Dzung C. Thach. (2009) LNA flow-FISH: A flow cytometry-fluorescence in situ hybridization method to detect messenger RNA using locked nucleic acid probes. Analytical Biochemistry 390 (2) 109-114.

All documents mentioned herein are hereby incorporated by reference for the purpose of disclosing and describing the particular materials and methodologies for which the document was cited.

Although the present invention has been described in connection with preferred embodiments thereof, it will be appreciated by those skilled in the art that additions, deletions, modifications, and substitutions not specifically described may be made without departing from the spirit and scope of the invention. Terminology used herein should not be construed as being “means-plus-function” language unless the term “means” is expressly used in association therewith.

What is claimed is:

1. A method of testing a potential antiviral compound, the method comprising:
providing cells infected with a virus,
contacting the cells with a candidate antiviral compound,
contacting the cells with a locked nucleic acid (LNA) probe directed at RNA of the virus under conditions suitable for hybridization, and
analyzing the cells with flow cytometry thereby detecting the presence or absence of the LNA probe in the cells.

2. The method of claim 1, further comprising permeabilizing the cells prior to contacting with the LNA probe.

3. The method of claim 1, wherein the LNA probe is directed at RNA corresponding to a structural component of the virus.

4. The method of claim 1, wherein the virus has an enveloped, single RNA genome.

5. The method of claim 1, further comprising staining the cells with a stain adapted to bind to the LNA probe.

6. The method of claim 5, wherein the LNA probe is biotinylated the stain comprises avidin and/or streptavidin

7. A method of monitoring viral infection, the method comprising:
providing cells known or suspected of being infected with a virus,
contacting the cells with a locked nucleic acid (LNA) probe directed at RNA of the virus under conditions suitable for hybridization,
staining the cells with a stain adapted to bind to the LNA probe, and
analyzing the cells with flow cytometry thereby detecting the presence or absence of the stain in the cells.

8. The method of claim 7, further comprising permeabilizing the cells prior to contacting with the LNA probe.

9. The method of claim 7, wherein the LNA probe is directed at RNA corresponding to a structural component of the virus.

10. The method of claim 7, wherein the virus has an enveloped, single RNA genome.

11. The method of claim 7, further comprising staining the cells with a stain adapted to bind to the LNA probe.

12. The method of claim 11, wherein the LNA probe is biotinylated the stain comprises avidin and/or streptavidin.

13. The method of claim 7, wherein the cells are analyzed at various times over the course of a single infection.
